(19) United States
(12) Patent Application Publication
(10) Pub. No.: US 2009/0234837 A1
(43) Pub. Date: Sep. 17, 2009

(54) SEARCH QUERY

(75) Inventor: Eugene Gladyshev, Los Gatos, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/048,792

(22) Filed: Mar. 14, 2008

(51) Int. Cl. G06F 17/30

(52) U.S. Cl. 707/5; 707/E17.071

(57) ABSTRACT

Embodiments of methods, apparatuses, or systems associated with result-query ranking information are disclosed.

### BACKGROUND

1. Field

The subject matter disclosed herein relates to search queries and, more particularly, to generating search queries.

2. Information

Information in the form of data is continually being generated or otherwise identified, collected, stored, shared, or analyzed. Databases or other like data repositories are common place, as are related communication networks and computing resources that may provide access to such information.

Tools or services are often provided which allow for large amounts of information to be searched. Search engines, as one example, may allow for one or more databases or other like data repositories to be searched. With so much information being available, there is a continuing need for methods or systems that may allow for pertinent information to be located or otherwise identified in an efficient manner.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a schematic diagram depicting an embodiment of a system for search phrase relevancy ranking;

FIG. 2 is a schematic diagram depicting another embodiment of a system for a search phrase relevancy ranking;

FIG. 3 is a schematic diagram depicting an embodiment of a system for result-query ranking information;

FIG. 4 is a schematic diagram depicting a networked embodiment of a system for result-query ranking information;

FIG. 5 is a flow chart depicting an embodiment of a method to compile result-query ranking information;

FIG. 6 is a flow chart depicting another embodiment of a method to utilize result-query ranking information;

FIG. 7 depicts an embodiment of a method to access result-query ranking information;

FIG. 8 depicts another embodiment of a method to access result-query ranking information.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context. Therefore, the particular context of the description or the usage of these terms may provide helpful guidance regarding inferences to be drawn for that particular context.

Likewise, the terms, “and,” “and/or,” and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

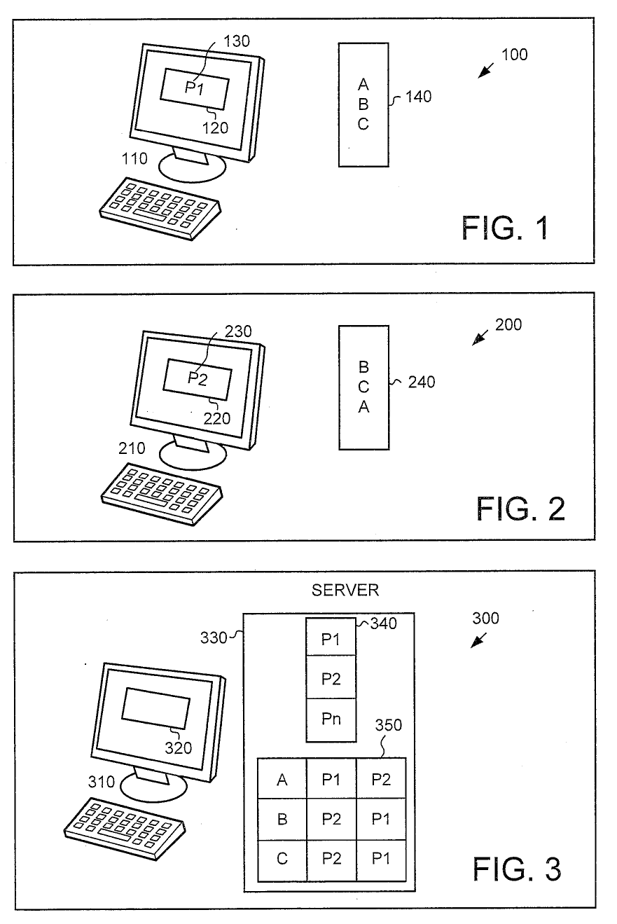

FIG. 1 is a schematic diagram depicting an embodiment 100 of a system for search phrase relevancy ranking. Embodiment 100 also includes computing platform 110 with search field 120 displayed thereon, in this example. Computing platform 110 is depicted as a personal computer (PC) in this embodiment. However, those skilled in the art will appreciate that computing platform 110 may comprise, but is not limited to, any particular device. In this context, therefore, computing platform 110 may comprise any device capable of performing mathematical or logical operations on data, which may also include being capable of storing the results of performing such operations.

Search field 120, as illustrated herein, allows users to input search queries, like search query 130, depicted as phrase P1, for example. Search field 120 is depicted in this embodiment as being capable of allowing search queries, such as text or symbols to be input, for example. However, search field 120 is of course not limited to any particular type of search query. Thus, search queries beyond text or symbols input into search field 120 may comprise any value capable of being represented in binary, but which may or take on a symbolic representation if displayed, such as for the purpose of performing mathematical or logical operations. Further examples of search query types that may be inputted into search field 120 include one or more files, characters, symbols, letters, words or other search query types, or combinations thereof.

Examples of a search field include those sometimes used to search data, such as may be found in, for example, Microsoft Word, Portable Document Format (PDF), spreadsheets or diagrams. Search field 120 may also be utilized to search databases of various forms, as may exist in some libraries or workplaces, for example. In this context, the term database refers to any at least partially organized collection or association of data stored at least in part by one or more data repositories. For example, a database may have one relation table or a plurality of relation tables, such as those that employ indexing. Additional examples of search fields similar to search field 120 include those sometimes used with Internet search engines, such as the Yahoo! search engine, for example, or others available on the World Wide Web. Of course, claimed subject matter is not limited to these examples.

Claimed subject matter is also intended to encompass any data capable of being searched, regardless of form. In addition, although search field 120 is depicted as displayed on computing platform 110, in some instances it may not be displayed to one or more users, if any at all. In this embodiment, for example, one or more users may input one or more search queries without utilizing search field 120 or, for example, without the search query being displayed to the user at the time the search query is input.

Search query 130, depicted as phrase P1, is shown input into search field 120. As before, search query 130 is capable of being any value to be searched. By way of example and not limitation, search phrase 130 may comprise one or more files, characters, symbols, letters, words or other search query types, or combinations thereof.

Embodiment 100 depicts execution of a search, for search query 130, which in this embodiment results in displaying search results 140. Typically, configurations of search results, such as the results depicted within box 140, may often be displayed in order of relevancy determined at least in part by a search engine relevancy ranking. For example, in this embodiment search results for search query 130, which are depicted within box 140, may be characterized with “A” being the most relevant and “C” being the least relevant, according to a particular search engine relevancy ranking. Search result “B” is here shown as having a relevancy ranking which may be said to be less than “A” or may be said to be greater than “C.”

The mechanism by which some search engine relevancy ranking produces particular search results, such as search result A, search result B, or search result C, in this embodiment, or also the order of their relevancy, may often be the subject of proprietary technology or processes. In this particular context, however, the term search engine relevancy ranking refers to ordinal or cardinal ranking of one or more search results, produced by a search engine at least in part in response to one or more search queries, where search results may be ranked, for example, from most relevant to least relevant, or vice-versa, based at least in part on particular criteria applied by the particular search engine.

Of course, determination of the particular search engine relevancy ranking for a particular search query may be implemented in any one of a host of forms. To illustrate one form of relevancy ranking, for example, assume phrase P1, in embodiment 100, is the term “Gorge.” Assume also that the particular search engine relevancy ranking used in this illustration searches and ranks electronic documents only. One form of relevancy ranking, for example, identifies such documents containing the term “Gorge” and may tend to rank those documents based in some measure on how frequently the term may be found within the document. Thus, those documents containing the term “Gorge” more frequently may generally be ranked higher, or deemed more relevant, than those documents containing relatively fewer instances of the term “Gorge.” Continuing the illustration, term location, another possible indication of relevancy, for example, if employed to rank relevancy may tend to rank documents based at least in part on where in a particular document the term “Gorge” may be found. Thus, those documents with “Gorge” in the document title, for example, may be ranked higher, or deemed more relevant, than those documents containing the term “Gorge” in what may be deemed a less conspicuous location, such as a footnote, for example.

Also, alluded to previously, it sometimes may be that search engine relevancy ranking ascribes some ordinal or cardinal value to one or more search results. Thus, for example, again referring to box 140, it may be suggested that search result A>search result B>search result C. Or, as may be illustrated, where relevancy may be assigned a value from 0 to 1, as an example, a particular search engine relevancy ranking may determine the relevancy of search result A to be 0.95, the relevance of search result B to be 0.70, and the relevance of search result C to be 0.55, thereby producing the rank illustrated by box 140. In addition, search engine relevancy ranking may also enlist some additional measures, like tracking click through measurement, for example—as may be the case in some Internet based search engines in part to help determine relevancy ranking.

While the above illustrations are greatly simplified, it is to be understood, however, that claimed subject matter is intended to cover any or all search engine relevancy rankings. This may comprise, for example, any methods, processes, or systems capable of at least in part producing one or more search results for one or more search queries.

Further, it will be understood by those skilled in the art that search results 140, while depicted here as search results A, B, C, may comprise, without limitation, any or all electronic data forms capable of being ranked by one or more search engine relevancy rankings. This may include, but is not limited to, for example, Word document data, spreadsheet data, Excel data, web page data, HTML data, rich text, PDF data, audio/visual data, or other data, regardless of form.

With reference now to FIG. 2, embodiment 200 depicts computing platform 210 within which search field 220 is displayed. Search query phrase 230, here illustrated as phrase P2, is shown in search field 220. Similar to the embodiment depicted in FIG. 1, for example, embodiment 200 illustrates a search, for phrase P2, which in this embodiment displays search results 240. In this embodiment, search results depicted within box 240 may be characterized with “B” being the most relevant and “A” being the least relevant, according to the particular search engine relevancy ranking shown. Search result “C” is here depicted as having a relevancy ranking which may be said to be less than “B” or may be said to be greater than “A.”

FIG. 3 is a schematic diagram depicting embodiment 300 that includes a system which may be used to compile result-query ranking information. In this context, the term compiling refers to a collection or other association of data, the collection or other association of data being arranged in a fashion so as to be capable of providing information regarding relevancy relationships among the compiled data.

Computing platform 310 is depicted with search field 320 displayed thereon. In this embodiment, computing platform 310 communicates with computing platform 330. Thus, via search field 320, computing platform 310 in effect is able to search data residing on computing platform 330. Search queries P1 and P2, the search queries utilized in FIGS. 1 and 2, respectively, are depicted in this embodiment as being compiled in search query database 340.

Computing platform 310 and computing platform 330 are depicted in what may be termed by some as a client/server arrangement, although the scope of claimed subject matter is of course not limited by this characterization. It is understood, however, that a computing platform, such as 310, may be enabled to communicate with other computing platforms via various communications links either now known or to be later developed. Thus, for example, computing platform 330 may operate to serve data to other computing platforms, which may operate as clients. Computing platform 330 may therefore, for example, function as a repository for some or all of the data for a network or other systems, including providing data storage functions, communication or broadcast functions, database functions, or various other functions that may be provided by a server, for example.

As discussed above in this embodiment, search query database 340 compiles search queries P1 and P2, which were entered into search field 320 for the purpose of searching computing platform 330. In this embodiment, search query database 340 may comprise one or more databases capable of at least in part compiling one or more search queries. In addition to compiling search queries, search query database 340 may also compile other data, such as, data associated with characteristics of users or user devices, or data relating to attributes of a particular search, for example. Illustrative examples of a search query database compiling associated characteristic data or attribute data are discussed in more detail below.

In this embodiment, search query database 340 is stored at least partially in the memory of computing platform 330, for example. Thus, in this embodiment, search query database 340, for example, may compile additional search phrases entered into search filed 320, as further depicted by search phrase Pₙ, shown in search query database 340. Those skilled in the art will appreciate, however, that search query database 340 may in some embodiments reside across a variety of memories or platforms. For example, as depicted below, search query database 340 may exist on one or more computer platforms, in whole or in part, or on one or more media, such as on CD, DVD, Flash, magnetic tape, or Zip to provide only a few examples.

Referring again to embodiment 300, and as depicted previously by FIGS. 1 and 2, in this example, search query phrases P1 and P2 have been entered into search field 320, which was utilized to search computing platform 330. Assume, for example, that search engine relevancy ranking of computing platform 330 produced a relevancy ranking of A, B, C for search query phrase P1, and a relevancy ranking of B, C, A for search query phrase P2.

With reference to search results A, B, or C, it may become apparent that search query phrase P1 may be more relevant for a user desiring to obtain search result A, while search query phrase P2 may be more relevant for a user desiring to obtain search result B, as suggested by FIGS. 1 and 2. Thus, the data structure depicted in result-query ranking information 350 may be compiled. Although, of course, this is merely one embodiment and claimed subject matter is not limited to this particular data structure.

Referring again to FIG. 3, in this embodiment, result-query ranking information 350 depicts search results A,B,C as being assigned one or more search queries in order of relevancy. For example, search result “A” is assigned search query phrases P1 and P2 in order of relevancy. Search result “B” is also assigned search query phrases P2 and P1 in order of relevancy. The order of relevancy ranking depicted in result-query ranking information 350 is determined by the search engine relevancy ranking, which, in this embodiment, is the search engine relevancy ranking applied by computing platform 330.

Of course, claimed subject matter is not limited to the previous embodiment. For example, in one alternative embodiment, search query database 340 may index search queries, such as by creating relational tables, for example. Thus, search query database 340 may assign a search query an identifier, such as a number or character, for example, that may serve to represent the search query. Identifiers may be indexed in a relational table, for example, to correspond to a particular search query. Alternatively, in other embodiments, search queries may be related via a relational table using an approach other than indexing.

Likewise, result-query ranking information may be capable of assigning search results to one or more search queries identifiers, which correspond to one or more search queries. As just described, search query database 340 may be capable of assigning an identifier, such as a number or character, for example, to a search query. Thus, result-query ranking information may store an identifier, for example, which may correspond to a search query stored at least in part in one or more search query databases. Alternatively, in yet another embodiment, search query database 340 or result-query ranking information 350 may not comprise separate databases. Thus, for example, search queries entered into one or more search engine relevancy rankings may be compiled by a search query database which may be part of, or related to, a database storing result-query ranking information.

Again referring to embodiment 300, result-query ranking information 350 is depicted as being stored on computing platform 330. As mentioned previously, result-query ranking information 350 may be stored or communicate in any manner described previously. Thus, any manner of storage, communication, or other operation, with respect to information 350 is encompassed within claimed subject matter. Likewise, search query database 340 or result-query ranking information 350 are capable of operating in conjunction with one or more programs, operations, or systems.

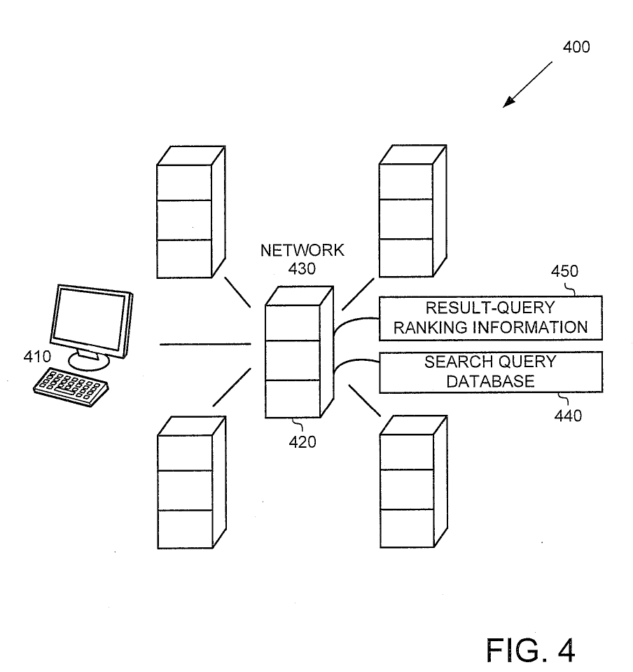

FIG. 4 is a schematic diagram depicting networked embodiment 400 of a system for result-query ranking information. Computing platform 410, again shown as a PC, is further depicted as being communicatively coupled to network 430. Computing platform 420, here shown as a server, for example, is illustrated as being communicatively coupled to network 430.

In addition to the embodiments previously described, many other uses or arrangements of one or more networks, including client/server systems, are known. It is intended that all such uses or arrangements are encompassed within the scope of claimed subject matter. Thus, for example network 430 may comprise networks of any type, including, for example, client/server networks or peer-to-peer networks to provide only a few examples.

In embodiment 400, for example, one or more users may be utilizing the Yahoo! search engine to input one or more search queries, for example. As in a typical interaction, for example, client computing platform 410 may request information from computing platform 420, which may then further request information from another server in network 430. In this embodiment, search query database 440 or result-query ranking information 450 are depicted as being stored on computing platform 420. It is to be understood, however, that search query database 440 or result-query ranking information 450 may be stored as a single database, or may be stored as a plurality of databases, which may be stored separately from one another or may be stored in whole or in part across one or more computing platforms.

As depicted in this embodiment, search query database 440 or result-query ranking information 450 may operate consistent with the operation illustrated by previous embodiments, for example. Thus, for example, search query database 440 may compile one or more search phrases or other data. Similarly, result-query ranking information 450 may be communicatively linked to search query database 440 or to one or more computing platforms capable of search engine relevancy ranking via network 430.

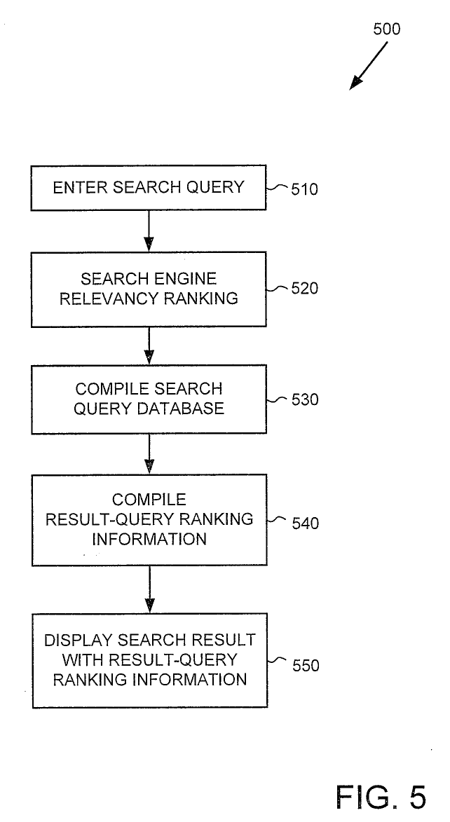

FIG. 5 is a flow chart depicting embodiment 500 of a method to compile result-query ranking information. It is to be understood, of course, that embodiment 500 may include subject matter encompassed in other embodiments previously described as well as other subject matter. Embodiment 500 depicts operation 510, in which one or more search queries are entered. Operation 520 is shown as a search engine relevancy ranking. In this embodiment, operation 530 compiles one or more search queries entered into operation 520. Operation 520 produces one or more search results which, in this embodiment, are compiled in operation 540. Additionally, in this embodiment operation 540 compiles search query data from operation 520. Operation 550 depicts, in this embodiment, data compiled via operation 540 being displayed with search result data produced by operation 520. As mentioned previously, any operation depicted in embodiment 500 may operate in accordance with any of the previously described embodiments, for example, however, claimed subject matter is of course not limited to these particular embodiments.

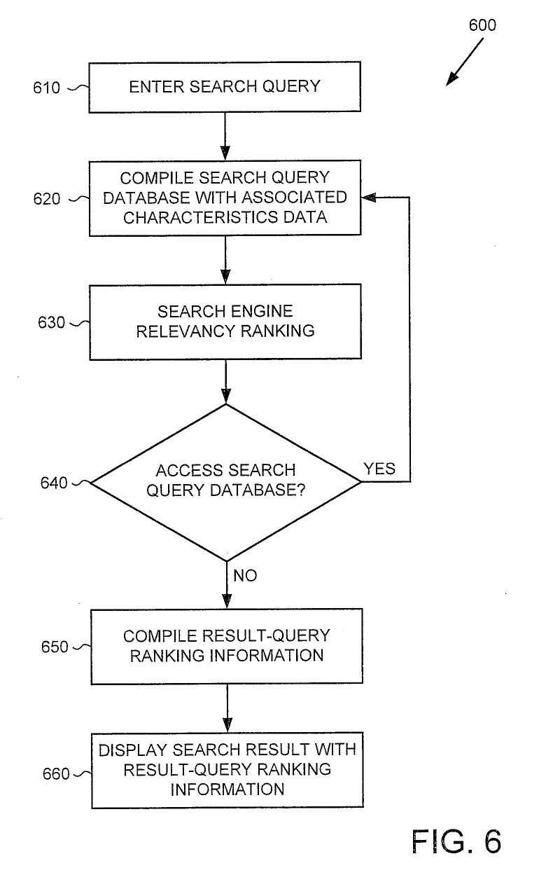

FIG. 6 is a flow chart depicting an embodiment 600 of a method to utilize result-query ranking information. Embodiment 600 shows operation 610, in which one or more search queries are entered. Operation 620 is illustrated compiling characteristics data, in addition to compiling one or more search queries. In this context, for example, characteristics data may include data relating to one or more users or user devices. Thus, for example, characteristic data may include data such as a user's static IP address. In an alternative embodiment, operation 620 may compile data relating to attributes of one or more searches. In this context, for example, such data may include data such as the time a user entered a search, for example.

Operation 630 is shown performing search engine relevancy ranking for one or more search terms entered into operation 610. In this embodiment, operation 640 is depicted as a decision. Operation 630, for example, may choose to access operation 620 or provide search results produced to operation 650.

If decision 640 is “yes” in FIG. 6, for example, operation 620 may provide data, such as associated characteristics data, attribute data, or other data, to operation 630. To illustrate, data from operation 620 may allow operation 630 to adjust the relevancy ranking produced for one or more search results, for example. Adjusted ranking produced by operation 630 may be compiled by operation 650. Similarly, if decision 640 is “no” in FIG. 6, for example, search results are not to be adjusted. In an alternative embodiment, adjusted ranking, such as produced by operation 630 may be displayed to one or more users or user devices without being compiled by operation 650. Operation 660 depicts display of search results along with result-query ranking information.

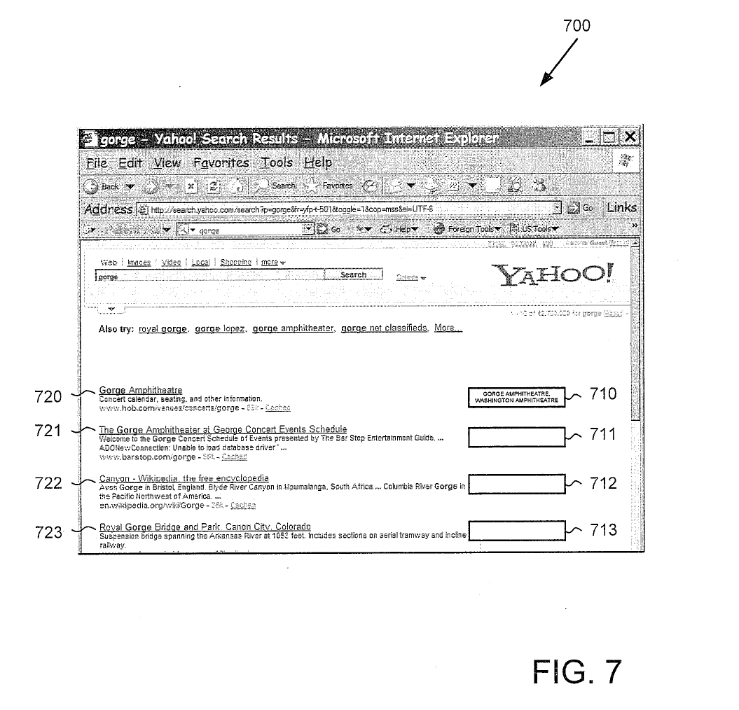

FIG. 7 depicts an embodiment of a method to access result-query ranking information. This embodiment illustrates two examples in which result-query ranking information may be accessed. In this context, access means capable of obtaining or making use of data, at least in part. Of course, claimed subject matter is not limited to any particular manner in which result-query ranking information may be accessed, nor is it limited to any particular devices used to perform such access. Nonetheless, in this embodiment, for example, access may comprise displaying, querying, requesting, searching, viewing, or utilizing result-query ranking information. Result-query ranking information may be accessed by one or more search engine relevancy rankings, end-users, computing platforms, programs, operations, or systems, to provide a few examples.

Referring again to FIG. 7, for example, this embodiment shows result-query ranking information being displayed on 700 as bit maps, depicted as 710-713, which is being displayed with search results shown in 720-723. Thus, search results listed on 700 may illustrate one way in which search results may be typically displayed by search engine relevancy ranking. In this embodiment, result-query ranking information is shown as being displayed adjacent to the search result. Thus, for example, result-query ranking information depicted in bit map 710—the search queries “gorge amphitheatre,” and “Washington amphitheatre,”—are being displayed to correspond to search result 720—“George Amphitheatre” found at www.hob.com/venues/concerts/gorge—for example. Of course, those skilled in the art will appreciate that display of result-query ranking information need not be limited to any particular manner of display. Accordingly, result-query ranking information may be displayed in any manner and all manners of display are intended to be encompassed within claimed subject matter. For example, result-query ranking information may be displayed as a link, a file, drop-down menu, or in other manners of display, to provide a few examples.

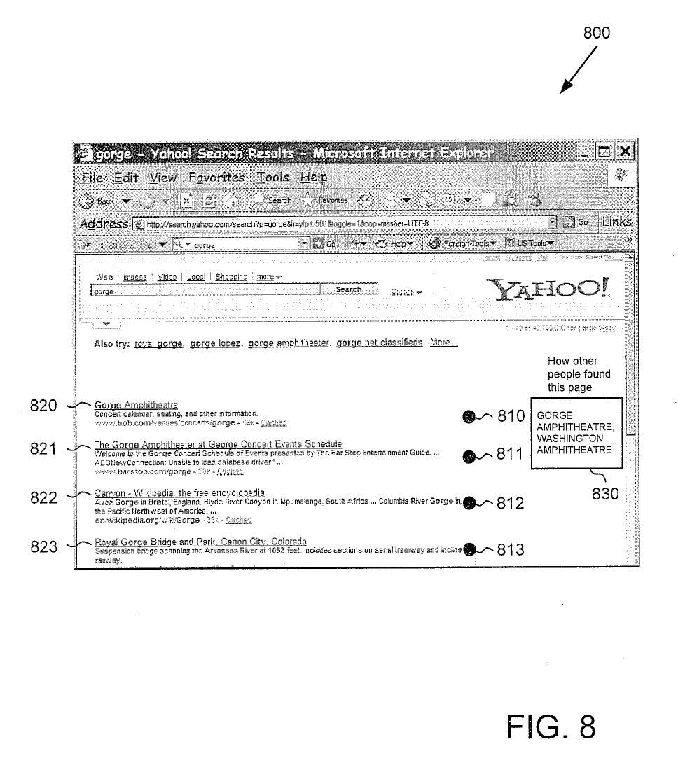

FIG. 8 depicts another embodiment of a method to access result-query ranking information. In this embodiment, unlike the embodiment in FIG. 7, result-query ranking information may not immediately be viewable on 800 via the display device. Instead, for example, result-query ranking information is accessible via a plurality of buttons, depicted as 810-813, displayed with search results, depicted as 820-823. As depicted in this embodiment, for example, one or more users may direct or occasion one or more computing platforms to display result-query ranking information by, for example, selecting one or more buttons.

Thus, as depicted in this embodiment, selecting one or more buttons, such as button 810, for example, may result in the display of pop-up window 830. Pop-up window 830 may display result-query ranking information similar to result-query ranking information displayed in bit map 710 in FIG. 7, for example. In this embodiment, the text “How other people found this page” is shown displayed with result-query ranking information, illustrated in pop-up window 830. The text above pop-up window 830 may, for example, inform a searcher that one or more queries listed in the window may be relevant.

It is again to be understood that the displays depicted in embodiment FIG. 7 or 8 are merely illustrative and do not limited claimed subject matter. Thus, for example, result-query ranking information may be displayed in any manner, which may include displaying result-query ranking information as one or more hyperlinks or drop-down menus, as previously suggested.

One advantage of the above embodiments may be, for example, that users may spend less effort searching for relevant search queries. For example, a user may input a search query and scroll down a list of search results returned by a search engine relevancy ranking. The user may refine the search query or use another search query, for example. Result-query ranking information that may be displayed or otherwise accessible for one or more desired search results, or results similar to the ones desired, may provide users one or more search phrases that may be more relevant, for example, than prior search phrases used. Another related advantage of embodiment, for example, may be a reduction in the burden on resources utilized to effectuate searching.

As mentioned with regard to FIGS. 3 and 6 above, a search query database is capable of compiling other data along with search queries. Referring again to FIG. 3, to illustrate, for example, search query database 340 may compile data relating to a particular user, say Jane Doe, who is logged into computing platform 310 of embodiment 300. Search query database 340 may compile data regarding Jane Doe's characteristics, such as her cookie information available to a search engine, or other available data, as a simple example, along with compiling one or more search queries. Thus, were Jane Doe to input the phrase “red hats”, for example, which may be entered by user such as Jane Doe, this search query along with various characteristics data may be compiled.

In another embodiment, for example, search query database 340 may also compile other data relating to attributes of a particular search. For example, search query database 340 may compile data relating at least in part to the time or location of a search executed by a user or a user device. We note, of course, that claimed subject matter is not limited to these examples. Likewise, in an alternative embodiment, search query database 340 need not contain any such data. Thus, search queries compiled in search query database 340 may be complied without any other data. In yet another embodiment, even when compiling data users may remain anonymous.

Data stored in a search query database may be utilized for a virtually limitless variety of purposes consistent with claimed subject matter. For example, one or more search engine relevancy rankings may be adjusted, as was alluded to herein in above embodiments. For example, a particular search engine relevancy ranking may access data relating to Jane Doe's cookie information, for example, while producing the relevancy ranking for the search query “red hats.” The search engine may adjust its relevancy ranking, for example, based at least in part on Jane Doe's cookie information, which may suggest Jane Doe may be requesting information about The Red Hat Social Club, for example. Likewise, as another simple example, a search engine relevancy ranking may adjust the ranking of one or more search results for the search query “discotheques,” based at least in part on compiled data showing the user or user device inputted the search query late at night and thus may be looking for a night club, and not just a dance club, for example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
compiling result-query ranking information for one or more search results.

2. The method of claim 1, wherein said compiling result-query ranking information comprises compiling one or more search query databases.

3. The method of claim 2, wherein said compiling one or more search query databases comprises compiling one or more search queries.

4. The method of claim 2, wherein said compiling one or more search query databases comprises compiling associated characteristics data.

5. The method of claim 2, wherein said compiling one or more search query databases comprises compiling attributes of one or more searches.

6. The method of claim 1, wherein said compiling result-query ranking information comprises accessing one or more search engine relevancy rankings, at least in part.

7. The method of claim 1, wherein said compiling comprises indexing one or more search queries.

8. The method of claim 1, wherein said compiling comprises assigning said one or more search results to one or more search queries.

9. A method comprising:
accessing result-query ranking information for one or more search results.

10. The method of claim 9, wherein said accessing result-query ranking information comprises accessing one or more search query databases.

11. The method of claim 10, wherein said accessing one or more search query databases includes accessing associated characteristics data.

12. The method of claim 10, wherein said accessing one or more search query databases includes utilizing data stored on said one or more search query databases to adjust a relevancy ranking at least in part produced by a search engine relevancy ranking.

13. The method of claim 9, wherein said accessing result-query ranking information comprises displaying result-query ranking information.

14. The method of claim 13, wherein said displaying result-query ranking information comprising displaying said result-query ranking information along with search query results.

15. The method of 13, wherein displaying said result-query ranking information includes displaying said result-query ranking information on a web page.

16. An apparatus comprising: a computing platform; said computing platform being capable of compiling result-query ranking information for one or more search results.

17. The apparatus of claim 16, wherein said computing platform being capable of compiling a search query database.

18. The apparatus of claim 16, wherein said computing platform is communicatively coupled to a network.

19. An article comprising: a storage medium having instructions stored thereon; said storage medium, if said instructions are executed, further instructing a computing platform to compile result-query ranking information for a search result.

20. The article of claim 19, wherein said instructions, if executed, further result in said computing platform to compile one or more search query databases.
